(19) United States
(12) Patent Application Publication
(10) Pub. No.: US 2015/0166039 A1
(43) Pub. Date: Jun. 18, 2015

(54) SHIFT CONTROL METHOD IN DCT VEHICLE

(71) Applicants: Hyundai Motor Company, Seoul (KR); Kia Motors Corp., Seoul (KR)

(72) Inventors: Sung Hyun Cho, Yongin-si (KR); Ju Hyun NAM, Bucheon-si (KR); Hwan HUR, Gunpo-si (KR); Ho Sung KIM, Anyang-si (KR)

(73) Assignees: Hyundai Motor Company, Seoul (KR); Kia Motors Corp., Seoul (KR)

(21) Appl. No.: 14/500,158

(22) Filed: Sep. 29, 2014

(30) Foreign Application Priority Data
Dec. 18, 2013 (KR) 10-2013-0157839

(51) Int. Cl. B60W 10/11; F16H 61/02; B60W 10/06

(52) U.S. Cl. CPC B60W 10/11; B60W 10/06; F16H 61/0204

(57) ABSTRACT

A shift control method in a vehicle having a dual clutch transmission may include determining whether power-off downshifting is being carried out, monitoring whether a tip-in is caused by a driver during the power-off downshifting, releasing all of a transmission torque of a releasing clutch and a transmission torque of a coupling clutch if it is determined that the tip-in is caused during the power-off downshifting, decreasing an engine torque at a point of time when an engine speed becomes identical to a speed of a coupling input shaft on which a target gear is disposed, and synchronously increasing the engine torque by gradually increasing the transmission torque of the coupling clutch and gradually reducing an amount by which the engine torque is decreased when the releasing clutch has completed a releasing action and the engine speed becomes faster than the speed of the coupling input shaft.

### CROSS-REFERENCE(S) TO RELATED APPLICATION

The present application claims priority to Korean Patent Application Number 10-2013-0157839 filed Dec. 18, 2013, the entire contents of which is incorporated herein for all purposes by this reference.

### BACKGROUND OF THE INVENTION

1. Field of the Invention

The present invention relates to a shift control method in a vehicle having a dual clutch transmission (DCT) (hereinafter referred to as the “DCT vehicle”), and more particularly, to a control technology for preventing a shift shock at the occurrence of a tip-in in which a driver steps on an accelerator pedal during power-off down shift.

2. Description of Related Art

A DCT is a transmission that uses two clutches as well as a transmission mechanism of a conventional manual transmission, in which an actual gear shift is carried out through conversion of the coupling status of two clutches.

With an automatic transmission having a conventional torque converter, it is relatively easy to achieve a smooth and appropriate feeling of shifting since the torque converter absorbs a shock that occurs during shifting through fluid slip. In contrast, a DCT does not have a device which absorbs a shock that occurs during shifting since it does not have a torque converter. In the DCT, the two clutches must be very precisely controlled during shifting in order to achieve a smooth and appropriate feeling of shifting. When the two clutches are implemented as dry clutches, more precise control is required.

A tip-in situation in which a driver steps on an accelerator pedal during the power-off downshifting refers to a situation in which the driver steps on the accelerator pedal while downshifting to a lower gear is being carried out in the state in which the driver has not stepped on the accelerator pedal. Since this tip-in is not a typical type of shift, there is very high possibility that a shifting shock will occur if the shifting is not specifically controlled.

The information disclosed in this Background of the Invention section is only for enhancement of understanding of the general background of the present invention and should not be taken as an acknowledgement or any form of suggestion that this information forms the prior art already known to a person skilled in the art.

### BRIEF SUMMARY

Various aspects of the present invention are directed to providing a shift control method in a DCT vehicle having dry clutches, in which a smooth and proper feeling of shifting can be achieved when a tip-in occurs in which a driver steps on an accelerator pedal while power-off downshifting to a lower gear is being carried out in the state in which the driver has not stepped on the accelerator pedal, by which the quality of shifting of the DCT vehicle can be realized and thus the value of the DCV vehicle can be improved.

According to various aspects of the present invention, a shift control method in a vehicle having a dual clutch transmission may include the following steps of determining whether or not power-off downshifting is being carried out, monitoring whether or not a tip-in is caused by a driver during the power-off downshifting, releasing all of a transmission torque of a releasing clutch and a transmission torque of a coupling clutch if it is determined that the tip-in is caused during the power-off downshifting, decreasing an engine torque at a point of time when an engine speed becomes identical to a speed of a coupling input shaft on which a target gear is disposed, and synchronously increasing the engine torque by gradually increasing the transmission torque of the coupling clutch and gradually reducing an amount by which the engine torque is decreased when the releasing clutch has completed a releasing action and the engine speed becomes faster than the speed of the coupling input shaft.

The shift control method may further include determining an entrance point of time when to begin the decreasing the engine torque after releasing all of the transmission torque of the releasing clutch and the transmission torque of the coupling clutch and before decreasing the engine torque.

Determining the entrance point of time may include determining whether or not the entrance point of time has arrived, the entrance point of time preceding the point of time when the engine speed is expected to be identical to the speed of the coupling input shaft by a delay time that is expected to take until the engine torque will be decreased actually after starting of the decreasing the engine torque, wherein decreasing the engine torque is started at the entrance point of time.

Increasing the engine torque by gradually increasing the transmission torque of the coupling clutch may include controlling a gradient, at which the transmission torque is increased until passing through a touch point, to be gentler than a gradient at which the transmission torque is increased after the touch point during a process in which the coupling clutch is engaged.

Increasing the engine torque by gradually reducing the amount by which the engine torque is decreased may include controlling the engine torque to increase while staying smaller than the transmission torque of the coupling clutch.

Increasing the engine torque by gradually reducing the amount by which the engine torque is decreased may further include controlling a gradient at which the engine torque is increased until passing through the touch point of the coupling clutch to increase gently compared to a gradient after the touch point like the transmission torque of the coupling clutch.

The shift control method may further include completing a shift by stopping control if a difference between the engine speed and the speed of the coupling input shaft converges to a value that is equal to or smaller than a reference value and stays to be equal to or smaller than the reference value for a reference time after synchronously increasing the engine torque is started.

According to various aspects of the present invention, a smooth and proper feeling of shifting can be achieved when a tip-in occurs in which a driver steps on an accelerator pedal while power-off downshifting to a lower gear is being carried out in the state in which the driver has not stepped on the accelerator pedal, by which the quality of shifting of the DCT vehicle can be realized and thus the value of the DCV vehicle can be improved.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a flowchart showing an exemplary shift control method in a DCT vehicle according to the present invention; and

FIG. 2 is a graph illustrating an exemplary shift control method in the DCT vehicle according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

According to various aspects of the present invention, a vehicle having a dual clutch transmission (DCT) employs a controller to perform a series of steps in a shift control method in the DCT vehicle.

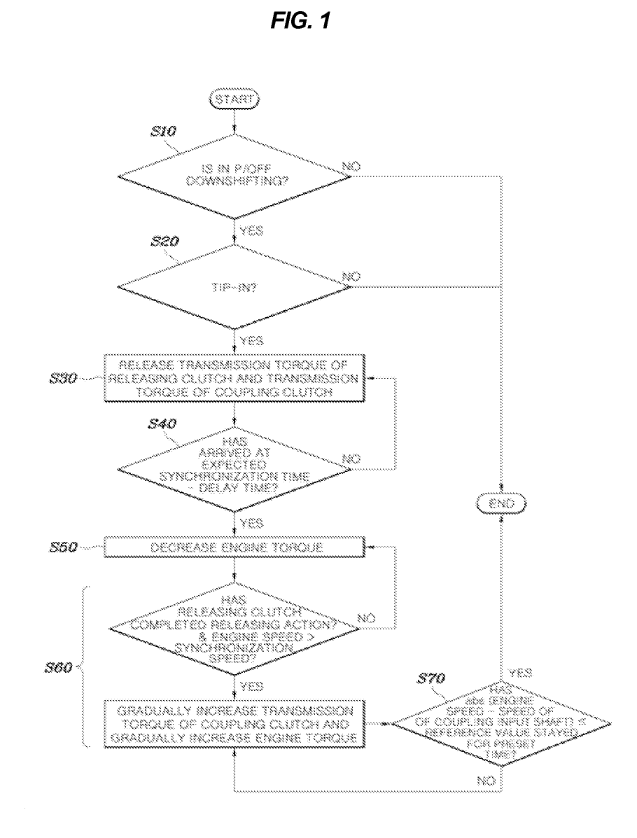

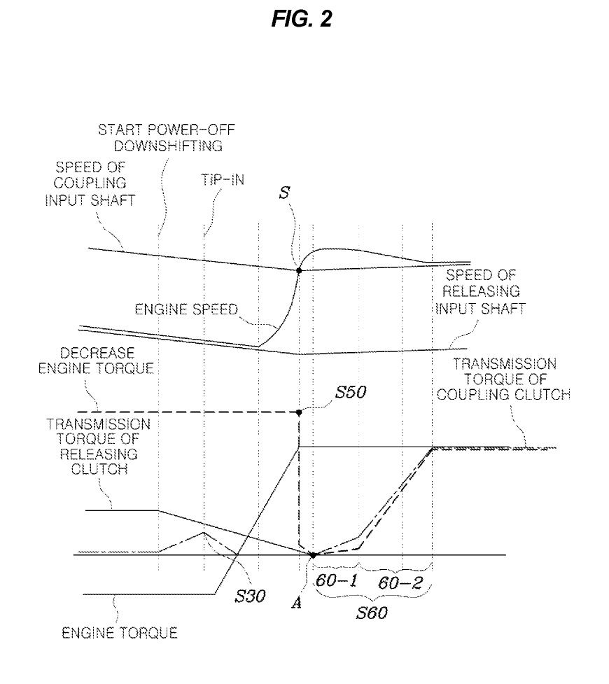

Referring to FIG. 1 and FIG. 2, an exemplary shift control method in the DCT vehicle according to the present invention includes a shifting determination step S10 of determining whether or not power-off (P/OFF) downshifting is being carried out, a tip-in monitoring step S20 of monitoring whether or not a tip-in is caused by a driver during the power-off downshifting, a torque release step S30 of releasing all of a transmission torque of a releasing clutch and a transmission torque of a coupling clutch if it is determined that the tip-in is caused during the power-off downshifting, an engine torque decreasing step S50 of decreasing an engine torque at a point of time S when an engine speed becomes identical with a speed of a coupling input shaft (synchronization speed) on which a target gear is disposed, and a synchronization induction step S60 of increasing the engine torque by gradually increasing the transmission torque of the coupling clutch and gradually reducing the amount by which the engine torque is decreased when the releasing clutch has completed a releasing action and the engine speed becomes faster than the speed of the coupling input shaft.

When the tip-in occurs during the power-off downshifting, the shift control method according to various aspects of the present invention carries out the torque release step S30 of releasing the transmission torque of the releasing clutch which is about to execute the releasing action as well as the transmission torque of the coupling clutch by operating the coupling clutch which is about to execute a coupling action, thereby primarily preventing the engine torque from suddenly increasing that would otherwise cause a shock to the coupling clutch. After the engine torque is decreased at the engine torque decreasing step S50, the engine is synchronized with the coupling clutch at the synchronization induction step S60 so that the shifting can be completed. Accordingly, the shift can be suitably controlled without a shock.

After the synchronization induction step S60 is started, if the difference between the engine speed and the speed of the coupling input shaft converges to a value that is equal to or smaller than a reference value and stays to be equal to or smaller than the reference value for a reference time at a synchronization confirmation step S70, the shift is completed by stopping the control so that the control over the shift is reliably finished.

The difference between the engine speed and the speed of the coupling input shaft converging to be equal to or smaller than the reference value indicates that synchronization between the engine and the coupling input shaft is substantially completed. The reference value can be decided to be in the range, approximately, from 50 to 100 RPM. The reference time indicates that the synchronized state is stabilized, and is a value that can be suitably decided through experiment and analysis.

The shift control method according to this embodiment further includes an entrance time determination step S40 of determining an entrance point of time when to enter the engine torque decreasing step S50 after starting of the torque release step S30 and before beginning the engine torque decreasing step S50. For this, the entrance time determination step S40 determines whether or not the entrance point of time has arrived. The entrance point of time precedes the point of time S when the engine speed is expected to be identical with the speed of the coupling input shaft by a delay time that is expected to take until the torque will be decreased actually in the engine after starting of decreasing the engine torque. The engine torque decreasing step S50 is started at the entrance point of time.

Specifically, when a controller calculates the point of time S when the engine speed is expected to be identical with the speed of the coupling input shaft and the engine torque decreasing step S50 is started at the point of time S, the engine torque is decreased substantially when the engine speed is faster than the speed of the coupling input shaft due to the delay time after the engine speed was identical with the speed of the coupling input shaft. Accordingly, the entrance time determination step S40 causes the engine torque decreasing step S50 to start in consideration of the delay time.

For reference, in FIG. 2, the start of the engine torque decreasing step S50 is indicated with the same point of time as the point of time S when the engine speed is expected to be identical with the speed of the coupling input shaft.

The engine torque decreasing step S50 causes all of the transmission torque of the releasing clutch and the transmission torque of the coupling clutch to be zero (0) by causing the engine torque to be zero (0) (point A in FIG. 2), and afterwards, the synchronization induction step S60 is started.

When the transmission torque of the coupling clutch is increased gradually at the synchronization induction step S60, the gradient at which the transmission torque is increased until passing through a touch point is controlled to be gentler than the gradient at which the transmission torque is increased after the touch point during the process in which the coupling clutch is engaged.

In control over the dry clutch, since a shock occurs when the dry clutch is engaged too suddenly until passing through the touch point, the coupling clutch is engaged in a relatively gentle fashion until passing through the touch point, and after that, the transmission torque is increased at a relatively steep gradient. Consequently, the shifting can be controlled as rapidly as possible while a shift shock is prevented.

In addition, when the engine torque is increased by reducing the amount by which the engine torque is decreased at the synchronization induction step S60, the engine torque is controlled to increase while staying smaller than the transmission torque of the coupling clutch. Like the transmission torque of the coupling clutch, the gradient at which the engine torque is increased until passing through the touch point of the coupling clutch is controlled to increase gently compared to the gradient after the touch point.

The engine torque is controlled to increase while staying smaller than the transmission torque of the coupling clutch for the following reason: Since the current state is the flare state in which the engine speed is increased to be greater than the speed of the coupling input shaft, the transmission torque of the coupling clutch must be controlled to be greater than the engine torque in order to synchronize the engine flare with the speed of the coupling input shaft.

The engine torque is increased by a relatively small value while the transmission torque of the coupling clutch is increased in order to satisfy the driver's expectation by rapidly accelerating the vehicle since the driver has stepped on the accelerator pedal.

For reference, in FIG. 2, the region where the gradient of the transmission torque of the coupling clutch and the gradient of the engine torque are gentle is indicated with 60-1, and the region where the gradient of the transmission torque of the coupling clutch and the gradient of the engine torque are steep is indicated with 60-2.

Controlling the DCT vehicle in the above-described method when a tip-in occurs during power-off downshifting can allow the shifting to be finished as rapidly as possible and impart the feeling of acceleration in response to driver's manipulation of the accelerator pedal while preventing a shift shock. This can consequently improve the value of the vehicle.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof It is intended that the scope of the invention be defined by the Claims appended hereto and their equivalents.

What is claimed is:

1. A shift control method in a vehicle having a dual clutch transmission, comprising:
determining whether or not power-off downshifting is being carried out;
monitoring whether or not a tip-in is caused by a driver during the power-off downshifting;
releasing all of a transmission torque of a releasing clutch and a transmission torque of a coupling clutch when it is determined that the tip-in is caused during the power-off downshifting;
decreasing an engine torque at a point of time when an engine speed becomes identical to a speed of a coupling input shaft on which a target gear is disposed; and
synchronously increasing the engine torque by gradually increasing the transmission torque of the coupling clutch and gradually reducing an amount by which the engine torque is decreased when the releasing clutch has completed a releasing action and the engine speed becomes faster than the speed of the coupling input shaft.

2. The shift control method according to claim 1, further comprising:
determining an entrance point of time when to begin the decreasing the engine torque after releasing all of the transmission torque of the releasing clutch and the transmission torque of the coupling clutch and before decreasing the engine torque, wherein determining the entrance point of time comprises:
determining whether or not the entrance point of time has arrived, the entrance point of time preceding the point of time when the engine speed is expected to be identical to the speed of the coupling input shaft by a delay time that is expected to take until the engine torque will be decreased actually after starting of the decreasing the engine torque, wherein decreasing the engine torque is started at the entrance point of time.

3. The shift control method according to claim 1, wherein increasing the engine torque by gradually increasing the transmission torque of the coupling clutch comprises:
controlling a gradient, at which the transmission torque is increased until passing through a touch point, to be gentler than a gradient at which the transmission torque is increased after the touch point during a process in which the coupling clutch is engaged.

4. The shift control method according to claim 3, wherein increasing the engine torque by gradually reducing the amount by which the engine torque is decreased comprises controlling the engine torque to increase while staying smaller than the transmission torque of the coupling clutch.

5. The shift control method according to claim 4, wherein increasing the engine torque by gradually reducing the amount by which the engine torque is decreased further comprises controlling a gradient at which the engine torque is increased until passing through the touch point of the coupling clutch to increase gently compared to a gradient after the touch point like the transmission torque of the coupling clutch.

6. The shift control method according to claim 1, further comprising completing a shift by stopping control if a difference between the engine speed and the speed of the coupling input shaft converges to a value that is equal to or smaller than a reference value and stays to be equal to or smaller than the reference value for a reference time after synchronously increasing the engine torque is started.
